(19) United States
(12) Patent Application Publication
(10) Pub. No.: US 2014/0270901 A1
(43) Pub. Date: Sep. 18, 2014

(54) Zip Fasteners and Binders

(71) Applicant: Rodney M. Shields, Ukiah, CA (US)

(72) Inventor: Rodney M. Shields, Ukiah, CA (US)

(21) Appl. No.: 14/213,087

(22) Filed: Mar. 14, 2014

Related U.S. Application Data
(60) Provisional application No. 61/789,984, filed on Mar. 15, 2013.

(51) Int. Cl. B42F 13/06

(52) U.S. Cl. CPC B42F 13/06
USPC 402/7

(57) ABSTRACT

An apparatus and method for binding sheets of material, comprising two mating binding strips are placed on opposite sides of a stack of sheets of perforated material, such that retaining surfaces can hold the sheets of material together in a bound volume. The binding strips mate via retaining straps that lock using a zip or ratcheting mechanism in the fastening head. At least one retaining tooth on the fastening head catches with a ratchet tooth on the retaining strip. In one preferred embodiment, one binding strip has at least two flexible retaining strips of notched material having at least one surface covered with detents, ridges, or retaining teeth. The female binding strip (or “locking strip”) has a plurality of fastening heads with locking mechanisms such as pawls. Each fastening head receives a retaining strip through a receiving passageway oriented in the same plane as the sheets of bound material.

This invention relates to systems and methods for binding pages for use in printing and publishing. In particular, this invention relates to novel reusable modular retaining strip bindings that can be used to hold together pages of paper in booklet. This application claims benefit under 35 U.S.C. §120 of the filing date for application No. 61/789,984 filed Mar. 15, 2013.

### BACKGROUND OF THE INVENTION

A number of different types of binders for sheets of paper are known, including two- and three-ring binders, comb binders (e.g., the General Binding Company system), spiral binders, tape bindings, prong-fasteners (e.g., Acco fastening binders), and thermoplastic binding strips (e.g., the velobind system). Each of these different binders has pros and cons. For example, ring binders allow easy addition and removal of pages, but are generally bulky. In contrast, comb, tape, and thermoplastic strip bindings create relatively streamlined bindings, but are essentially permanent, and do not allow addition and removal of pages after the binding has been created. Prong fasteners are both low profile and adjustable, but require the use of relatively expensive metallic components. Also, with frequent re-use, the metallic flanges can wear out and break.

Also known in the art are variations on the above art that utilize serrated or grooved strips with to create ratcheting bindings. For example, Sun et al. (EP 241,690) describe a bookbinding method utilizing bifurcated posts having facing notched surfaces, wherein the bifurcated posts are fed through a “locking button” strip having pawls that insert down into the perforations in the bound sheets of paper and match the notched surface of the bifurcated posts to create a locked grip holding the binding in place. Similarly, Staats (U.S. Pat. No. 4,997,208) describes a variation on thermoplastic binding strips that uses notched posts that grip the inner surface of matching perforations in the paper being bound. In both of these cases, the binding, once formed, may not be adjusted to increase the thickness of bound sheets. Although Sun describes a tool that may be used to unlock the pawl from the bifurcated posts, thereby allowing non-destructive removal of the binder, Sun also instructs the user to cut off excess post length when assembling the binder. Accordingly, Sun did not disclose a binder that allowed the user to add sheets of paper to the binder after assembly.

### SUMMARY OF THE INVENTION

In the system of the invention, two pieces, or binding strips 10, are placed on opposite sides of a stack of perforated paper or sheets of other material 20 and locked together with a zip mechanism similar to the retaining strip on cable ties. The stack of sheets thus bound may vary in thickness. In one preferred embodiment, one binding strip 100 has at least two retaining strips 110 of notched material having at least one surface 115 covered with detents and/or ridges 120. The other binding strip 200, termed herein a “locking strip,” has a number of fastening heads 210 (e.g., pawl assemblies) situated on the surface of that binding strip, oriented in roughly the same plane as the sheets of bound material 20, with an aperture 220 and receiving passage 230 complimentary to the notched retaining strips 110, capable of receiving the retaining strips 110 and locking them in place, with excess retaining strip length 130 directed down the length of the locking strip 200. In preferred embodiments of the invention, the locking strip 200 is a generally cuboid shape forming one half of the spine of the bound book thus formed, with the pawl assembly situated within a roughly cuboid recess 240 within the locking strip, such that with excess length 130 of the retaining strip slides into and is hidden within the cuboid recess 240.

Because the retaining strips 110 extend through perforations 25 in the bound material 20 out the other side and are then flattened along the length of the spine of the binding, the profile of the binding remains fairly low, permitting combination with a flat cover and/or spine around the sheets. The retaining strip 110 is preferably a flattened tongue or similar shape presenting a long, low profile along the plane of the bound sheets, and is preferably smooth on the paper side 116 when locked into position so as to prevent tearing or abrasion of the apertures in the sheets being assembled or dissembled. In the preferred embodiment, a hand-releasable pawl 215 allows the user to release the ratcheting surface 115 from its locked position so the binder 300 may be dissembled. Once dissembled, sheets of paper may be added or removed, and the binding assembly may be reassembled to bind the new volume of sheets. The present invention thus combines the advantage of low profile with the ability to open the binding to add or remove sheets of paper with reuse of the binder. It allows the use of relatively inexpensive plastics rather than requiring metal components.

A further goal of the invention is to allow the creation of bindings of various external shapes and profiles, each of which is of sufficient volume to contain the above-described pawl assembly and recess. In this way, different decorative shapes may be created for the binding as a whole.

### DESCRIPTION OF THE FIGURES

FIG. 1 shows a cutaway cross-sectional view of male 100 and female 200 binding strips 10 of one preferred embodiment of the invention before assembly.

FIG. 2 shows a cutaway cross-sectional detail view of the male 100 and female 200 binding strips of the preferred embodiment of FIG. 1 in a locked position after assembly.

FIG. 3 shows a cutaway view of an alternate preferred embodiment in which each of two binding strips 10 has one retaining strip 110 and one fastening head 210 arranged in a complimentary fashion, after assembly.

FIG. 4 shows a facial view of the binding assembly with bound paper. FIG. 5 shows a facial view of embodiments in which the binding assembly is molded into various shapes.

FIG. 6 shows a cutaway view of an embodiment using a pawl assembly with a spring tab, a pivot point, and a push button.

FIG. 7 shows a detail of a variation of the zip locking mechanism is adapted to use within a picture frame.

### DETAILED DESCRIPTION OF THE INVENTION

In the system of the invention, two mating binding strips 100 are placed on opposite sides of a stack of sheets of perforated material 20 (e.g., paper), such that retaining surfaces 101 can hold the sheets of material 20 together in a bound volume 400. The binding strips are allowed to mate via flexible retaining straps 110 that lock into place using a zip or ratcheting mechanism in the fastening head 210. When locked in place, at least one retaining tooth 220 on the fastening head 210 catches with a ratchet tooth 120 on the retaining strip 110. In one preferred embodiment, one binding strip 100 has at least two flexible retaining strips 110 of notched material having at least one surface 115 covered with detents, ridges, or retaining teeth 120. The female binding strip 200 (or “locking strip”) has a plurality of fastening heads 210 with locking mechanisms such as pawls 215. Each fastening head 210 is oriented so it receives the retaining strip through a receiving passageway 211 primarily oriented in the same plane as the sheets of bound material 20.

In one embodiment, the fastening heads 210 are opposite the retaining surface 101 of the locking strip 200. Each fastening head 210 has a receiving passageway with receiving aperture 212 with a shape complimentary to that of its matching retaining strip 110. The fastening head 210 is thus capable of receiving each matched retaining strip and locking it in place when at least one retaining tooth 220 is in contact with at least one ratchet tooth 120. Excess length 130 of the retaining strip 110 is directed along the surface 101 of the locking strip along the spine of the bound volume.

In one preferred embodiment of the invention, the locking strip 200 is a partially hollowed first shape forming the spine 300 of the bound book 400 formed after assembly. A pawl assembly 215 is situated within a recess 240 within the locking strip 200. When mated with its matching male binding strip 100, the locking strip 200 contains the length of the retaining strip 110 within the recess 240. Alternately, the locking strip 200 may comprise a solid strip without the recess 240, and the fastening heads may be situated on the external surface 102 of the locking binding, opposite the retaining surface. In yet another embodiment, shown in FIGS. 1 and 2, the locking strip 200 contains bevels 10 that raise the interior face 101 of the locking strip 200 off of the surface of the bound sheets 20. The fastening head 210 is located interiorly on the locking strip 200, with a total height substantially identical to the height of the edge bevels 10. The retaining strip 110 then feeds through the receiving aperture 212 and passageway 211 and is forced to run parallel to the interior face 101 of the locking strip 200. The bowing of the flexible retaining strip 110 helps press the ratchet teeth 120 against the pawl's retaining tooth or teeth 115, locking the first binding strip 100 into place on the opposite side of the bound sheets.

The fastening head 210 comprises at least one receiving passage 230 that accepts the retaining strip 110 via the receiving aperture 220. The fastening head further comprises a pawl mechanism 215. Those of skill in the art will recognize that different types of pawl assemblies may be used, in which different types of spring mechanisms may be utilized. In most of these pawl assemblies, the pawl 215 will include a release mechanism, comprising a depressible member 216 that creates leverage to release the retaining tooth 217 from the ratchet tooth 115 of the retaining strip

Because the retaining strips 110 extend through perforations 25 in the bound material 20 out the other side and are then flattened along the length of the spine of the binding, the binding presents a relatively thin completed profile, permitting combination with a flat cover and/or spine around the sheets. The retaining strip 110 is preferably a slim rectangular cuboid or similar shape presenting a long, low profile along the plane of the bound sheets, and is preferably smooth on the paper side 116 when locked into position so as to prevent tearing or abrasion of the perforations in the sheets being assembled or dissembled. In a preferred embodiment, a hand-releasable pawl 215 allows the user to release the ratcheting surface 115 from its locked position so the binder may be dissembled. Once dissembled, sheets of paper may be added or removed, and the binding assembly may then be reassembled to bind the new volume of sheets. The present invention thus combines the advantage of low profile with the ability to open the binding to add or remove sheets of paper with reuse of the binder. It allows the use of relatively inexpensive plastics rather than requiring metal components.

FIG. 1 shows a pair of matched binding strips 10, with retaining strips 110 that are adjustable so that they can bind together stacks of paper ranging in thickness from a few sheets to several inches of sheets. As shown in FIG. 2, the two retaining strips are fed through holes 25 in the stack of paper. In a common use the strips can be spaced to fit the top and bottom hole spacing on standard three-hole punched paper, or any other spacing desired. The retaining strips 110 feed through the paper and into the fastening head 210 on the opposing binding strip. Press the two pieces together and they squeeze and lock the stack of papers together. The retaining strip 110 can be constructed from any material that is suitably flexible and durable, especially plastics of appropriate flexibility, such as polypropylenes, polyamides, polyesters, and nylons. The ridges or notches arrayed on the locking surface of the retaining strip can vary in their exact shape.

In one preferred embodiment of the invention, two buttons 216 on the bottom piece release the pawl 215 when pressed to remove the bindings to easily add or remove pages, as shown in FIG. 2. The release button 216 can be spring-tensioned as shown in FIG. 6. One of skill in the art will recognize that a number of alternate pawl or lock mechanisms could be used to control the lock/unlock mechanism holding the retaining strip in place. Alternatively, the buttons 216 can be omitted (or snapped off by the person who binds the item) to create a permanent binding that is much easier than other methods (such as velobinding) to assemble and does not require any specialized equipment.

One of ordinary skill in the art will recognize that variations on this basic set up are possible. For example, the binding 300 can be constructed of two binding strips 10 in which each binding strip has a retaining strip 110 on one end and a fastening head 210 on the far end, as shown in FIG. 3. In another embodiment, a mating pair can be formed with a shared edge 310 or identical parallel edges 315 connected by a coterminous third panel 320, where one binding strip 10 can flipped over to interlock with its mate to form a completed binding, as in FIG. 7. This embodiment presents the advantage of requiring only one set of tooling for manufacturing. Similarly, although the embodiments shown in FIGS. 1-3 involve only two retaining strips 110, the invention could accommodate one or more additional retaining strips with matching fastening heads 210 on the opposite binding strip. For example, a binder with three retaining strips could be manufactured to accommodate standard three-hole sheets of 8½″×11″ paper.

A person of skill in the art will recognize that variations of retaining strip 110 with different forms of teeth 115 are possible. Although FIGS. 1-3 show squared detents, it may often be preferable to have teeth whose surfaces form triangular profiles when viewed from the side of retaining strip 110. The angle formed by the contact surface of the retaining teeth and the backing of the retaining strip 110 will preferably be between 80° and 120°, with the retaining tooth 215 of the pawl mechanism 210 angled in a complementary manner to form an optimal lock.

The binding of the invention is not limited to use along a particular edge of bound sheets. The binding can be used along any edge of the sheets of bound material that can be perforated. For example, the binding can be used along the sides of a stack of papers or along the top edge as desired.

A further goal of the invention is to allow the creation of bindings of various external shapes and profiles. As seen in FIG. 4, the binding can include attached front and rear covers with many different colors and styles of report covers to create attention grabbing presentations. Alternatively, as shown in FIG. 5, different decorative shapes 300a-d may be chosen, each different shape is of sufficient volume to contain the above-described pawl assembly and recess. Other shapes can also be used. The bindings thus created can be used for Scrapbook projects, photo albums, self published books, manuals, guides, presentations, and reports.

The bindings can also be customized with logos or messages. The binding strips can have areas that are designed to accept stickers. FIG. 5 shows an example with the pencil binder strip and the “Hill Valley School” sticker. If desired, the entire strip area can be designed to accept a sticker. These stickers can be designed on a computer and then printed out in a standard computer printer. Customers can design their own binders with pictures, logos, and messages of their own choosing. A design kit could include a binder elements, instructions with design ideas, print-your-own peel-and-stick labels and pre-printed stickers. The release button for the pawl mechanism can be incorporated into the design. For example, one set of bindings could be done in the shape of a pen and one would click the end of the “pen” to activate the release button. Another in the shape of a pencil, with the release button incorporated in the “eraser”.

FIG. 6 shows an alternate embodiment of the invention in which the fastening head is integrated with the locking strip 200 on a surface that contacts the bound sheets 20. The retaining strip 110 extends through the aperture 211 and is engaged by the locking mechanism of the pawl 215. One embodiment uses a spring tab, a pivot point, and a push button. The ratchet is released by spring tension. A one piece construction could also be used. This embodiment contains both a male side and a female side, which flip over and mate with each other.

FIG. 7 shows a variation of the invention where the zip clip mechanism is used to lock members of a picture frame into place. In this embodiment, the locking mechanisms would be at opposing corners.

1. An apparatus for binding sheets of material, comprising:
a first binding strip,
at least two retaining straps attached to the first strip, each of the at least two binding strips being flexible and having at least one surface covered with retaining teeth;
a second binding strip, said second binding strip having a number of fastening heads equal to the number of retaining straps attached to the first binding strip, placed on the second binding strip at a complementary position to the retaining straps on the first binding strip, said fastening heads comprising a pawl mechanism with a locking tooth capable of coupling to the retaining teeth of at least one retaining strap.
